(19) United States
(12) Patent Application Publication
(10) Pub. No.: US 2004/0149733 A1
(43) Pub. Date: Aug. 5, 2004

(54) Shaped heaters and uses thereof

(76) Inventors: Richard C. Abbott, New Boston, NH (US); Gary P. Magnant, Topsfield, MA (US)

Correspondence Address: CLARK & ELBING LLP, 101 FEDERAL STREET, BOSTON, MA, 02110, US

(21) Appl. No.: 10/743,677

(22) Filed: Dec. 22, 2003

Related U.S. Application Data
(62) Division of application No. 10/219,205, filed on Aug. 15, 2002, now abandoned.

(51) Int. Cl. H05B 3/58

(52) U.S. Cl. 219/535

(57) ABSTRACT

The present invention features shaped resistive heaters, uses thereof, and methods for their fabrication. The heaters are shaped such that they can conform to all or part of an object, e.g., an injection mold. The heaters may be permanently bonded to the object, or they may be adjacent to the object but not adhered, having the advantage of being removable and replaceable. The heaters include an electrically resistive element, which is, for example, a plate, a wire coil, or a deposited layer. Exemplary resistive elements are fabricated by thermal spray.

### BACKGROUND OF THE INVENTION

The invention relates to the field of resistive heaters.

Resistive Heaters

A resistive heater produces heat by the collision of electrons with the atoms of the heater material. The rate at which heat is generated is the power, which depends on the amount of current flowing and the resistance to the current flow offered by the material. The resistance of a heater depends on a material property termed “resistivity,” and a geometric factor describing the length of the current path and the cross-sectional area through which the current passes.

Injection Molding

Many plastic and metal parts, for example, aluminum automobile transmission housings or polycarbonate computer cases, are manufactured by injecting molten metal or polymer melt into a complex cavity cut into steel. Injection-molding machinery melts a thermoplastic or metal powder in a heating chamber and forces it into a mold, where it hardens. The operations take place at rigidly controlled temperatures and intervals. In an injection molding process, it is important to maintain the material, such as polycarbonate, in a molten state as it flows into and through a mold cavity space. Additionally, the shear stress profile of the flow of resin is desirably monitored and managed to insure proper filling of the cavity space. If the molten resin solidifies too rapidly when it encounters a cold mold, it may not penetrate narrow cavities and/or may form weak knit lines where two flows intersect.

Blow Molding

In blow molding, a thermoplastic tube called a parison is extruded or injection molded. The hot parison is then inserted in a cold mold, and air or another gas is forced into the parison causing it to expand to fill the mold. This technique is commonly used in the manufacturing of plastic bottles. In this technique, the cold mold limits the fineness of detail that can be achieved since the polymer freezes upon making contact with the walls of the mold. Thus, only crude features are currently obtainable in blow-molded products.

Rotational Molding

Rotational molding is useful for the production of hollow containers. A powdered polymer is placed in the mold, and the mold is heated. After the polymer has melted, the mold is rotated and cooled. As the mold is rotated, the molten polymer coats the surface of the mold, creating a hollow container in the shape of the mold. Cooling the mold allows the polymer to solidify. Heating and cooling the mold results in the process having long cycle times. Additionally, if the mold cools non-uniformly, then flaws may develop in the molded product.

Accordingly, much effort has been directed towards improving heat management and flow control in molding processes.

### SUMMARY OF THE INVENTION

The present invention features shaped resistive heaters, uses thereof, and methods for their fabrication. The heaters are shaped such that they can conform to all or part of an object, e.g., an injection mold. The heaters may be permanently bonded to the object, or they may be adjacent to the object but not adhered, having the advantage of being removable and replaceable. The heaters include an electrically resistive element, which is, for example, a plate, a wire coil, or a deposited layer. Exemplary resistive elements are fabricated by thermal spray.

Accordingly, in one aspect, the invention features a shaped resistive heater including a resistive element and an electrically insulating element, wherein the heater has a fixed, non-planar shape that is conformal to at least a portion of an object to be heated, and the heater is not adhered to the object.

In a related aspect, the invention features a method of heating an object. This method includes the steps of providing a shaped resistive heater as described above; placing the heater into conformal contact with the object; and applying current to the resistive element to produce heat. The method may further include the step of replacing the shaped heater with a second shaped heater after one or more applications of current to the resistive element.

The invention also features a mold that includes a shell having a cavity side that defines a mold cavity and a back side; a resistive heater including a resistive element and an electrically insulating element, wherein the heater is shaped to conform to at least a portion of the back side of the shell, and the heater is in conformal contact with the back side; and a housing capable of physically supporting the shell and the heater, wherein the heater is disposed between the shell and the housing. In one embodiment, the resistive heater is adhered to at least a portion of the back side. In an alternative embodiment, the resistive heater is not adhered to the shell. The shell also may or may not be adhered to the housing. The mold may also include a thermal barrier element disposed between the heater and the housing. This thermal barrier element may, for example, be adhered to the heater or to the housing, or may be freestanding. The mold may further include electrically insulating elements disposed between the resistive element and the back side and/or between the housing and the resistive element. A shell employed in the invention may have a thickness, for example, of greater than about 0.005, 0.05, 0.5, 1, 2, 6, or 12 inches or less than about 24, 12, 6, 2, 1, or 0.5 inches. A shell may be produced, for example, by electroplating, electroless deposition, molding, spray forming, machining, chemical vapor deposition (CVD), physical vapor depostion (PVD), or combinations thereof. Desirably, the mold includes a cooling jacket, e.g., located within a shell, a housing, a substrate in which a heater is disposed, or within a separate part of the mold.

In another aspect, the invention features a method of making a molded product. This method includes the steps of providing a mold as described above; heating the resistive heater by the application of current; and injecting a material to be molded into the mold, wherein the heated resistive heater regulates the solidification of the material, thereby forming the molded product. The method may further include the step of cooling the material in the mold, e.g., by flowing a liquid or gas through a cooling jacket. The material is, for example, a thermoplastic polymer, a metal, a thermoset polymer, a ceramic, a glass, a cermet, or any combination thereof. Other materials are known in the art.

The invention further features a method of making a mold. This method includes the steps of providing a shell having a cavity side that defines a mold cavity and a back side and a housing capable of physically supporting the shell; and depositing a resistive element on at least a portion of the back side, wherein when the shell is supported by the housing, the resistive element is disposed between the shell and the housing. The method may further include the steps of forming an electrically isolated, resistive heater path in the resistive element; and connecting the resistive heater path to a power supply, thereby fabricating a resistive heater. The forming step includes, for example, micromachining, microabrading, laser cutting, chemical etching, or e-beam etching. In one embodiment, the method further includes depositing an electrically insulating element on at least a portion of the back side of the shell before depositing the resistive element. In another embodiment, the method further includes depositing a thermal barrier element on at least a portion of the resistive element.

In another aspect, the invention features an alternative method of making a mold. This method includes the steps of providing a shell having a cavity side that defines a mold cavity and a back side and a housing capable of physically supporting the shell, wherein the cavity side defines a mold cavity; and forming a resistive heater that has a shape that is conformal to at least a portion of the back side. In this method, when the shell and the resistive heater are supported by the housing, the resistive element is disposed between the shell and the housing. In one embodiment, the forming of the resistive heater includes the steps of depositing a resistive element on at least a portion of an object replicating at least a portion of the shape of the back side; and removing the resistive element from said object. In an alternative embodiment, the forming step includes providing a second shell having a shape conformal to at least a portion of the back side; and depositing a resistive element on the second shell.

The above-described methods of forming a resistive heater may also include depositing an electrically insulating element on at least a portion of the object or second shell prior to depositing the resistive element, wherein the electrically insulating element is adhered to the resistive element. In other embodiments, either method of forming the resistive heater further includes depositing an electrically insulating element and/or a thermal barrier layer on at least a portion of the resistive element.

Shaped heaters or molds of the invention may include one or more resistive elements. These elements may be arranged such that they are conformal to the same object, e.g., a shell in a mold, or they may be arranged such that all or a portion of one heater is disposed between all or a portion of a second heater and a substrate, e.g., an object being heated. Shaped heaters or molds may also include one or more thermal sensors, e.g., an array of thermocouples. The thermal sensors may be disposed, e.g., in proximity to a heater or a surface being heated. In one embodiment, thermal sensors are arrayed over the entire object being heated. In an alternative embodiment, thermal sensors are placed in specific areas of the object being heated.

The resistive elements of the invention may include a Ni—Cr alloy, titanium (Ti), silicon (Si), aluminum (Al), zirconium (Zr), cobalt (Co), nickel (Ni), carbon (C), iron (Fe), silicon carbide, silicon nitride, or alloys thereof (such as FeCrAl, e.g., 72.2% Fe, 22% Cr, and 5.8% Al). Resistive elements may be formed, e.g., by thermal spraying, machining, casting, sintering, CVD, or PVD. In various embodiments, resistive heaters include two electrically insulating elements, wherein the resistive element is disposed between the electrically insulating elements. Exemplary materials for electrically insulating elements include aluminum oxide, silicon dioxide, boron nitride, aluminum nitride, zirconium oxide, and mica. A heater of the invention may also include a power supply that is electrically coupled to the resistive element, wherein the application of current from the power supply results in the production of heat by the resistive element. In various other embodiments, the heaters of the invention include a thermal barrier element, e.g., containing zirconium oxide or mullite. Thermal barrier layers may allow leakage of a certain amount of heat, e.g., into a fluid in a cooling jacket. A heater of the invention has a thickness, for example, of greater than 0.0001, 0.001, 0.01, 0.1, 1, or 10 inches and less than 30, 20, 10, 5, 1, 0.1, 0.01, or 0.001 inches. In desirable aspects, an element of the invention is a thermally sprayed layer.

By “shaped heater” or “shaped resistive heater” is meant a structure including a resistive element and having a fixed shape that conforms to an object.

By “resistive element” is meant an element, e.g., a wire, a plate, or a deposited layer, having an electrical resistivity of approximately >0.0001 Ω·cm. The value of resistivity will depend on the application.

By “electrically insulating element” is meant an element, such as a deposited layer or mica sheet, that does not conduct electricity.

By “electrically isolated” is meant not in electrical contact with any surrounding elements. Electrical connections made to an electrically isolated element will not provide voltage or current to the surrounding elements.

By “resistive heater path” is meant a resistive element that has been physically separated from a larger resistive element by, for example, masking during deposition or micromachining. A resistive heater path is typically electrically isolated from the larger resistive element.

By “thermal barrier” layer or element is meant a layer or element that prevents heat flow. Examples of thermal barrier elements are heat reflective and thermally insulating elements.

By “heat reflective” layer or element is meant a layer or element that has a low thermal emissivity, a low thermal absorptivity, and/or high thermal reflectivity. A heat reflective layer reduces heat loss from radiative transfer. Heat reflective elements are known to those skilled in the art.

By “thermally insulating layer or element is meant a layer or element that has a low thermal conductivity (typically about 0.01 to 5 W/m·K, e.g., about 2 W/m·K). A thermally insulating layer reduces heat loss by conduction. Thermally insulating elements are known to those skilled in the art.

By “fixed shape” is meant a solid shape that does not substantially change during standard use or handling. One skilled in the art will recognize that objects having a fixed shaped may be scratched, dented, and/or abraded during use or handling and may also expand and contract based on changes in temperature or pressure.

By “object” is meant a structure having a fixed shape, i.e., a solid.

By an object that “conforms to” or “is conformal to” another object is meant two objects that are shaped such that they can come into close contact. The closeness of contact required between objects will depend on the application, and one skilled in the art can make this determination. For a shaped heater, closer contact with an object results in the potential for more efficient transfer of heat.

By “object to be heated” is meant an object whose temperature is desirably elevated.

By “heating an object” is meant elevating the temperature of an object, e.g., above room temperature or above its melting point or glass transition temperature.

By an object “shaped similarly” to another object is meant shaped such that a shaped heater of the invention can conform to either object.

By “adhered to” is meant physically or chemically bonded to.

By “not adhered to” is meant not physically or chemically bonded to. A shaped heater that is not adhered to an object can be removed and replaced.

By “thermally sprayed” layer or element is meant a layer or element that has been deposited by a thermal spray technique.

By “substrate” is meant any object on which a layer is deposited. The substrate may be, e.g., bare metal, plastic, glass, graphite, glassy carbon, mica, or ceramic, or it may have one or more layers, e.g., an electrically insulating layer, on its surface.

By “shell” is meant an object that defines a mold cavity or is used as a casing for an object.

By “thermoplastic material” is meant a material capable of softening or fusing when heated and of hardening again when cooled. Exemplary thermoplastic materials include thermoplastic organic polymers. A “thermoplastic melt” is the softened or molten thermoplastic material.

By “thermoset material” is meant a material that irreversibly transforms from a liquid to a solid by chemical reaction upon exposure to heat. Examples of thermoset materials include thermoset epoxies and silicones.

By “thermal sensor” is meant a device for monitoring temperature, e.g., a thermocouple.

By “cycle time” is meant the time elapsed between a certain point in one cycle and that same point in the next cycle. For example, the cycle time for injection molding is measured as the time between injections of thermoplastic melt into a mold.

By “runner” is meant a channel that transports a thermoplastic melt from an entrance to a mold to the cavity.

Other features and advantages will be apparent from the description of the preferred embodiments, and from the claims.

### BRIEF DESCRIPTION OF THE DRAWINGS

FIGS. 1A-1F are illustrations of a method of fabricating a shaped heater.

FIG. 2A is an illustration of a cross section of a resistive heater deposited on the back of a shell.

FIG. 2B is an illustration of a cross section of a housing for a shell.

FIG. 2C is an illustration of a cross section of an injection mold including a resistive heater deposited on the back of a shell supported by a housing.

FIG. 3A is an illustration of a cross section of a shell used in a mold.

FIG. 3B is an illustration of a cross section of a shaped heater.

FIG. 3C is an illustration of a cross section of a housing.

FIG. 3D is an illustration of a cross section of a mold including a shell, a shaped resistive heater, and a housing.

### DETAILED DESCRIPTION

The present invention features a shaped resistive heater. The heater contains a resistive element that produces heat when current is applied and has a shape that is conformal to all or part of an object, such as a mold or a vacuum pump. The heater may be an integral part of the object or may be removable and replaceable. The present invention also features methods for using a shaped heater and methods for its fabrication.

Theory of Resistive Heaters

In order for a resistive element to generate heat when a voltage is applied, the element must have a resistance that is determined by the desired power level. The resistance, R, is calculated from the applied voltage, V, and the desired power level, P, from:

R=V²/P

The resistance is related to the geometry of the heater coating—the electric current path length, L, and the cross sectional area, A, through which the current passes—and also to the material resistivity, ρ, by the equation:

R=ρL/A

Therefore, to design an element for a given power level and a given geometry that will operate at a given voltage, one has only to determine the resistivity of the material by:

ρ=RA/L=V²A/PL

In most situations, the resistivity of the heater material, e.g., nichrome, is a fixed value. In such an instance, the heater designer must arrange the heater geometry (L and A) to obtain the desired power. For example, if it is desired to heat a tube by winding nichrome wire around it, the designer chooses the correct diameter wire for A, the cross sectional area through which the electric current must pass, and the spacing of the windings for L, the total path length of the electric current. In the thermal spray techniques described, e.g., in U.S. Pat. No. 5,420,395; U.S. application Ser. No. 09/996,183, filed Nov. 29, 2001; U.S. application Ser. No. 09/073,775, filed May 6, 1998; and U.S. application Ser. No. ______, filed Aug. 15, 2002, entitled RESISTIVE HEATERS AND USES THEREOF, the resistivity of an element, in this case a deposited layer, is determined by the materials and processes used in its deposition. That the resistivity can be a controlled variable is significant because it represents an additional degree of freedom for the heater designer.

Shaped Heaters

The shaped heaters of the present invention are designed to conform to an object, e.g., a mold, a pump housing, a valve body, or a pipe flange. The heater desirably conforms to a non-planar shape and has a fixed shape. Conformal contact allows for the efficient transfer of heat to the object. Non-adhesive, conductive pastes may be applied between the heater and the object to be heated to ensure efficient conduction of heat. Each heater includes one or more resistive elements that produce heat when electrical current is applied. A resistive element may span the heater, i.e., have essentially the same shape as the heater, or an element may be localized in a part of the heater. The resistive element may also be arranged such that the heater produces a non-uniform pattern of heat, e.g., a gradient. The heaters of the invention may be thin, e.g., at most approximately 1 cm thick, at most approximately 5 mm thick, at most approximately 1 mm thick, at most approximately 0.5 mm thick, or thinner. More than one shaped heater may be in conformal contact with an object, e.g., to encase an object completely. Such a set of heaters may be designed to fit together and may be fastened together. Shaped heaters may be held in contact with an object to be heated by standard means, e.g., clamps, bolts, belts, or surface tension.

Heaters may be formed by depositing layers, e.g., by screen printing, electroplating, electroless deposition, or thermal spray, on an object. The object is then optionally removed, e.g., by destroying the object or delaminating a deposited heater from the object. The object may be coated with release agents to aid in removal. Alternatively, a heater may be cast or shaped by standard machining techniques. The heater may remain attached to the object, or it may be removed. If the heater remains attached to the object, it is desirable for the object to have a shape that is conformal to at least part of another object, e.g., a molded part.

In addition to a resistive element, shaped heaters of the invention may also include one or more additional elements, including, without limitation, electrically insulating elements, bonding or adhesive elements, and thermal barrier elements. Other additional elements are described below. In certain embodiments, the heater includes a plurality of deposited layers, each of which may be patterned into a desired geometrical pattern, e.g., to radiate a specific pattern of heat. The resistive element may be disposed within the interior of a shaped heater, e.g., sandwiched between two or more additional elements.

Although the heaters of the invention are shaped to conform to an object, the heaters may be operated while free standing.

Resistive Elements

Any resistive element may be used in the invention provided that it has the appropriate resistivity for a particular application and that it is robust enough to provide a useful lifetime. The robustness of a heater depends on many factors, e.g., resistance to oxidation, temperature stability, mechanical stability, and ability to withstand a desired current load. The elements may be considered disposable, i.e., they may be discarded after, e.g., one use, 100 uses, 1000 uses, up to approximately 50,000 uses, or more. The number of desired uses and type of element employed may depend on the application and can be determined by one skilled in the art.

Examples of resistive elements that may be used in the invention include thick film resistive elements, ceramic elements, semiconductor elements, and metallic elements (e.g., nichrome elements). These elements may be fabricated, e.g., by screen printing resistive inks; by thermal spraying, e.g., resistive alloys (e.g. nichrome), mixtures of ceramics (as described in U.S. application Ser. No. 09/073,775), or a reactive metallic component and a reactant (as described in U.S. application Ser. No. 09/996,183 and U.S. application Ser. No. ______, filed Aug. 15, 2002, entitled RESISTIVE HEATERS AND USES THEREOF), or using resistive wires, plates, or tapes. Other methods are known to those skilled in the art.

Electrically Insulating Elements

The resistive element is separated from a conductive object or element, e.g., a metal layer, by an electrically insulating element. This insulating element may, for example, include a non-conductive ceramic, such as steatite, a non-conductive polymer, such as epoxy, a glassy layer, such as a porcelain layer, or mica. These insulating elements may be deposited, e.g., by thermal spray, screen printing, or casting from solution. For example, an epoxy layer may be screen printed on a metal substrate, and a metal powder can be pressed into the surface of the wet epoxy to serve as a bond layer for a thermally sprayed resistive element. Examples of electrically insulating ceramics that may be thermally sprayed on a conductive substrate include aluminum oxide, zirconium oxide, mullite, and magnesium oxide. In one embodiment, sheets of mica may be placed in contact with a resistive element in order to insulate the resistive element electrically.

In another embodiment, a metal element, e.g., one that provides structural stability, is porcelainized using standard techniques, for example, coating the metal with a powder and heating the powder to between 1200 and 1400° F. to melt the porcelain. Porcelain may be applied to a substrate, for example, by dip coating or screen-printing. Exemplary substrates for porcelain are steel, electroless nickel, copper, and aluminum. The exact type of porcelain is determined by factors, such as the type of substrate, the operating temperature of the heater, and desired chemical or physical properties. One skilled in the art can make this determination.

The resistive element may also be coated with an electrically insulating element to isolate it from conducting layers deposited on the resistive element. In one embodiment, a resistive layer, e.g., one containing silicon or zirconium, is treated, e.g., to oxidize its surface, to render its surface electrically and/or thermally insulating. Resistive elements may be deposited on a nonconducting surface without an intervening electrically insulating element.

Electrically insulating elements may also be machined, cast, sintered, or otherwise formed as a separate insert, e.g., a machined aluminum nitride plate disposed above a heating element.

Additional Elements

Other elements may be included in a heater to provide properties other than heat generation and electrical insulation. These additional elements may be deposited by thermal spray or by other techniques such as screen printing or deposition from a solution, e.g., electroplating or electroless deposition. Examples of additional elements include, without limitation, an adhesion layer for bonding different elements together (e.g., a nickel-aluminum alloy layer), an electrical contact element (e.g., copper or conductive porcelain contact pads), a thermally insulating element (e.g., one containing zirconium dioxide), a thermally emissive element (e.g., a chromium oxide layer), elements for improved thermal matching between elements with different coefficients of thermal expansion (e.g., a layer of nickel between layers of aluminum oxide and aluminum), a thermally conductive element (e.g., a layer of molybdenum), a machineable metal element (e.g., a layer of tungsten), structural elements (e.g., a steel or nickel support layer), elements to provide protection from chemical reaction or mechanical abuse (e.g., a tungsten carbide-cobalt layer), decorative elements, and a heat reflective element (e.g., a layer of tin). The elements included in a heater may be arranged in any appropriate order, e.g., the resistive element is separated from a metal support element by an electrically insulating element. The appropriate arrangement can be determined by one skilled in the art.

A thermal barrier element can be used to direct the flow of heat from a heater, e.g., towards a mold cavity. A thermal barrier layer may also be used to shield temperature sensitive areas, e.g., those containing sensitive electronics or those handled by personnel. Heat normally would radiate in all directions from a resistive heater, and thus thermal barrier layers allow for more efficient heating of an object or area by directing heat, which would otherwise be lost, in a desired direction. The use of heat reflecting elements also typically reduces the power consumption for a heater.

The ability to direct heat to specific regions allows for rapid thermal cycling. For example, a shaped resistive heater having a thermal barrier element is positioned near the cavity surface of a mold. When the heater is operated, the thermal barrier element directs heat towards the cavity surface without heating the remainder of the mold tool. This localized heating requires less time to reach a desired temperature and also allows for more rapid cooling since only a fraction of the volume of the mold is heated.

Thermal Spray

The resistive elements and other elements of a heater of the present invention may be deposited using a thermal spray apparatus. Exemplary thermal spray apparatuses include, without limitation, arc plasma, flame spray, ROKIDE® systems (Norton, Worcester, Mass.), arc wire, and high velocity oxy-fuel (HVOF) systems.

Thermally sprayed elements of the invention may be deposited on any suitable substrate. Exemplary substrates include metals, plastics, ceramics, mica, graphite, and glass. Elements may also be deposited on another element, e.g., a bonding or electrically insulating layer. The surface of the substrate may also be roughened, e.g., by grit blasting, prior to depositing an element by thermal spray. Thermally sprayed layers may also be sealed by a dielectric sealant, such as a silicone, glass-filled silicone, or nanophase material.

Patterned Elements

In an alternative embodiment, elements may be deposited in defined patterns. The pattern may be defined, for example, by a removable mask or tape. Other masking techniques include the use of dissolvable protective coatings. Patterned application allows for the fabrication of more than one spatially separated resistive element in one or more heaters. Patterned elements also allow controlled heating in localized areas.

An element may also be patterned by cutting or scribing a path in a bulk material, e.g., a deposited layer, by using a process such as micromachining or microabrading using commercially available equipment (e.g., from Comco Inc, Burbank, Calif. or S.S. White Technologies, Piscataway, N.J.). In microabrading, a blaster emitting an abrasive powder, e.g., aluminum oxide or silicon carbide, is used to abrade material in a defined area. Coupling the blaster to a multiaxis robot translator or motion controller enables the outlining of specific geometries in a material. For example, a resistive path outlined by microabrading is electrically isolated from the remainder of a deposited resistive layer. Microabrading can be controlled to cut through only one element, e.g., a resistive layer, while keeping other elements, e.g., an electrically insulating layer, intact. Microabrading eliminates the need for masking during deposition.

Other techniques for patterning, such as micromaching (e.g., cutting using a diamond tool), laser cutting, chemical etching, or e-beam etching are known in the art.

Applications

Application of a current through a resistive element in a shaped heater generates heat resistively. Connections between the power supply and the resistive element are made, for example, by brazing connectors, soldering wires, conductive epoxy, physical contact using various mechanical connectors, or by any other means known in the art. These shaped resistive heaters are advantageous in applications where localized heating is desired. Shaped heaters may also be incorporated into a system that requires heat, e.g., injection molding. In this embodiment, the shaped heater is placed in conformal contact with an object to be heated. If the heater fails for any reason, it can be removed and replaced with another heater having the same shape.

One application of a shaped heater of the invention is in injection molding. An injection mold has a cavity into which a melt of a thermoplastic or metal is forced. Once the material cools and hardens, it can be removed from the mold, and the process can be repeated. An injection mold of the invention includes a shaped heater in thermal contact with at least a portion of the surface of the cavity, e.g., the heater is within 0.03 inches of the cavity surface. The purpose of placing a heater near the cavity of a mold and in the conduits to that cavity is to better control the solidification process and reduce cycle times. Heaters in close proximity to the melt can be used to keep the melt hot so that it flows better with less pressure, and to cool the melt during the solidification phase in a controlled way. Heated molds will allow thin-walled parts to be produced, since a thermoplastic or metal will not freeze upon being injected into a heated mold. An example of a thin-walled part is a magnesium cell phone housing. The reduction in pressure required to inject a material in a heated mold allows for lower clamping pressures in injection molding machines and for the molding of larger parts or multiple smaller parts in a single mold. Exemplary materials for molds include nickel or other metals that have been electroplated, electroless plated, forged, molded, or thermally sprayed. In one embodiment, the shaped heater forms the cavity surface and may include a metal layer that contacts the molten material.

Heaters of the invention may also be employed in blow molding. A shaped heater near the interior surface of a blow mold can be heated to enable the production of hollow plastic parts with fine detail since the polymer will not freeze when contacted with a heated mold.

Molds for other molding techniques may also contain shaped heaters proximal to the surface of the mold. These techniques include, without limitation, rotational molding, pressure forming, vacuum forming, flash molding, thixotropic molding, and reactive injection molding. Materials that can be molded include, without limitation, thermoplastic materials, thermoset materials, metals, glasses, green cermets, ceramics, and fluoropolymers. Heaters of the invention can maintain thermoplastics or metals in a molten shape until they have completely filled a mold, i.e., the heaters can maintain a mold at a temperature equal to or greater than the melting point of a particular material.

Heaters of the invention can also be used to cure thermoset materials after they have been inserted in a mold. In one embodiment, a solid form having a shaped heater in thermal contact with its surface is dipped in a thermoset material, current is applied to generate heat, and the thermoset material hardens around the mold. The hardened thermoset material may then be ejected from the mold, which is reusable. The duration of heating determines the thickness of the molded part.

Additional applications of the heaters of the invention are as follows:

1. Blanket heater on pipe with metal contact layer on top and aluminum oxide insulator on the contact;

2. Heater tip for natural gas ignitor on kitchen stove, oven, water heater, or heating system;

3. Free standing muffle tube fabricated by sprayforming on a removable mandrel;

4. Low voltage heater coating for bathroom deodorizer;

5. Laboratory applications: Resistively heated coated glass and plastic lab vessels; work trays; dissection trays; cell culture ware; tubing; piping; heat exchangers; manifolds; surface sterilizing laboratory hoods; self-sterilizing work surfaces; sterilizing containers; heatable filters; frits; packed beds; autoclaves; self-sterilizing medical bacterial and tissue culture tools (e.g., loops and spreaders); incubators; benchtop heaters; flameless torches; lab ovens; incinerators; vacuum ovens; waterbaths; drybaths; heat platens; radiography pens; reaction vessels; reaction chambers; combustion chambers; heatable mixers and impellors; electrophoresis equipment; anode and cathode electrodes; heating electrodes; electrolysis and gas generation systems; desalinization systems; de-ionizing systems; spectroscopy and mass spectroscopy equipment; chromatography equipment; HPLC; IR sensors; high temperature probes; thermoplastic bags; cap and tube sealers; thermal cyclers; water heaters; steam generation systems; heated nozzles; heat activated in-line valves; shape-memory alloy/conductive ceramic systems; lyophilizers; thermal ink pens and printing systems;

6. Medical and dental applications: Self-sterilizing and self-cauterizing surgical tools (e.g., scalpel blades, forceps); incubators; warming beds; warming trays; blood warming systems; thermally controlled fluid systems; amalgum heaters; dialysis systems; phoresis systems; steamer mops; ultra high temperature incineration systems; self sterilizing tables and surfaces; drug delivery systems (e.g., medicated steam inhaler; thermal activated transcutaneal patches); dermatological tools; heatable tiles; wash basins; shower floors; towel racks; mini-autoclaves; field heater cots; body warming systems;

7. Industrial applications: Sparkless ignition systems; sparkless combustion engines; bar heaters; strip heaters; combustion chambers; reaction chambers; chemical processing lines; nozzles and pipes; static and active mixers; catalytic heating platforms (e.g., scrubbers); chemical processing equipment and machines; environmental remediaton systems; paper pulp processing and manufacturing systems; glass and ceramic processing systems; hot air/air knife applications; room heaters; sparkless welding equipment; inert gas welding equipment; conductive abrasives; heater water-jet or liquid-jet cutting systems; heated impellers and mixing tanks; fusion and resistance locks; super heated fluorescent bulbs that use new inert gases; heatable valves; heatable interconnects and interfaces of all types; heatable ceramics tiles; self heating circuit boards (e.g., self-soldering boards; self-laminating boards); fire hydrant heaters; food processing equipment (e.g., ovens, vats, steaming systems, searing systems, shrink wrapping systems, pressure cookers, boilers, fryers, heat sealing systems); in-line food processing equipment; programmable temperature grids and platens to selectively apply heat to 2-D or 3-D structures (e.g., thermoplastic welding and sealing systems); point pulsing heaters; battery operated heaters; inscribers and marking systems; static mixers; steam cleaners; IC chip heaters; LCD panel heaters; condensers; heated aircraft parts (e.g., wings, propellers, flaps, ailerons, vertical tail, rotors); conductive ceramic pens and probes; self-curing glazes; self-baking pottery; walk-in-ovens; self-welding gaskets; heat pumps;

8. Home and office applications: Heatable appliances of all types; self cleaning ovens; igniters; grills; griddles; susceptor-based heatable ceramic searing systems for microwaves ovens; heated mixers; impellers; stirrers; steamers; crock pots; pressure cookers; electric range tops; refrigerator defrost mechanisms; heated ice cream scoops and serving ladles; operated hand held heaters and warmers; water heaters and switches; coffee heater systems; heatable food processors; warmable toilet seats; towel racks; clothes warmers; bodywarmers; cat beds; instantly heated irons; water bed heaters; washers; driers; faucets; heated bathtubs and wash basins; dehumidifiers; hose nozzles for heated washing or steam cleaning; platens to heat moisturized wipes; bathroom tissue heaters; towel heaters; heated soap dispensers; heated head razors; evaporative chilling systems; self-heating keys; outdoor CO₂ and heat generating systems for bug attraction and killing systems; aquarium heaters; bathroom mirrors; chair warmers; heatable blade ceiling fans; floor heaters;

9. Whole surface geometric heaters; direct contact heaters; pure ceramic heating systems; coated metal heating systems; self-detecting fault systems; plasma sprayed thermocouples and sensors; plasma spheredized bed reaction systems (e.g., boron gas generation system for the semiconductor industry; heatable conductive chromatographic beds and beads systems); pre-heaters to warm surfaces prior to less costly or more efficient heating methods; sensors (e.g., heater as part of integrated circuit chip package);

10. Microwave and electromagnetic applications: Magnetic susceptor coatings; coated cooking wear; magnetic induction ovens and range tops;

11. Thermoplastic manufacturing applications: resistively heated large work surfaces and large heaters; heated injection molds; tools; molds; gates; nozzles; runners; feed lines; vats; chemical reaction molds; screws; drives; compression systems; extrusion dies; thermoforming equipment; ovens; annealing equipment; welding equipment; heat bonding equipment; moisture cure ovens; vacuum and pressure forming systems; heat sealing equipment; films; laminates; lids; hot stamping equipment; shrink wrapping equipment;

12. Automotive applications: Washer fluid heaters; in-line heaters and nozzle heaters; windshield wiper heaters; engine block heaters; oil pan heaters; steering wheel heaters; resistance-based locking systems; micro-catalytic converters; exhaust scrubbers; seat heaters; air heaters; heated mirrors; heated key locks; heated external lights; integral heater under paint or in place of paint; entry and exit port edges; sparkless “sparkplugs”; engine valves, pistons, and bearings; mini-exhaust catalytic pipes;

13. Marine applications: antifouling coatings; de-iceable coatings (e.g., railings, walkways); electrolysis systems; desalinization systems; on-board seafood processing systems; canning equipment; drying equipment; ice drills and corers; survival suits; diving suit heaters; desiccation and dehumidifying systems;

14. Defense applications: High temperature thermal targets and decoys; remora heaters; MRE heating systems; weapons preheaters; portable heaters; cooking devices; battery powered heatable knife; noncombustion based gas expansion guns; jet de-icing coating on wings etc; thermal fusion self destruction systems; incinerators; flash heating systems; emergency heating systems; emergency stills; desalinization and sterilization systems;

15. Signage applications: heated road signs, thermoresponsive color changing signs; inert gas (e.g., neon) impregnated microballoons that fluoresce in magnetic fields;

16. Printing and photographic applications: copiers; printers; printer heaters; wax heaters; thermal cure ink systems; thermal transfer systems; xerographic and printing heaters; radiographic and photographic film process heaters; ceramic printers;

17. Architectural applications: heated walkway mats, grates, drains, gutters, downspouts, and roof edges;

18. Sporting applications: heated golf club heads; bats; sticks; handgrips; heated ice skate edges; ski and snowboard edges; systems for de-icing and re-icing rinks; heated goggles; heated glasses; heated spectator seats; camping stoves; electric grills; heatable food storage containers.

In one embodiment, the heater of the present invention may be used in an injection molding system to manage and control the flow of the molten material throughout the mold cavity space. For some applications, the heater may generate variable amounts of heat across the surface of the mold cavity to allow for fine adjustments to the molten material temperature gradient, thus providing precise heat flow control and constant (or precisely-managed) viscosity and velocity of the melt flow. Mold heat management and flow control depend on the specific application and the type of material used.

Desirably, the heater is used in conjunction with a thermal sensor (e.g., a thermistor or thermocouple) and/or a pressure sensor. Direct deposit of the coating containing the heater onto the mold cavity area can reduce or eliminate air gaps between the heater and the heated surface, providing intimate and direct contact for improved temperature transfer between the heater and the heated surface.

The following examples are presented merely to illustrate various embodiments of the invention and are not meant to limit the invention in any way.

### EXAMPLE 1

### Fabricating a Shaped Heater

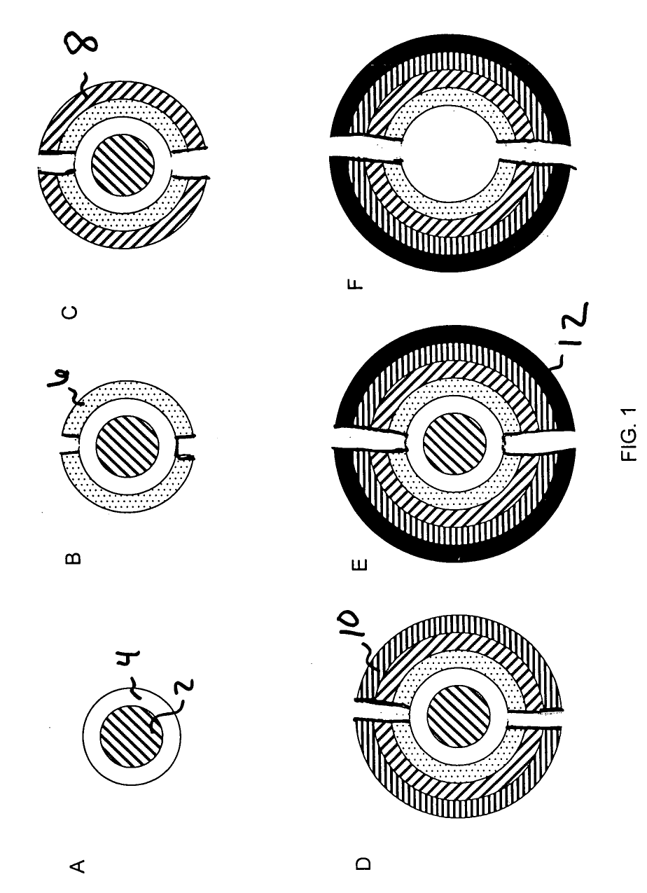

Shaped heaters may be fabricated in a number of ways. In one particular example, depicted in FIGS. 1A-1F, a layer of aluminum 4 is deposited on a steel pump part 2. A layer of aluminum oxide 6 (an electrical insulator) is then thermally sprayed on top of the aluminum. A layer of iron-chrome-aluminum is thermally sprayed in the presence of nitrogen and oxygen to form a resistive layer 8 on the aluminum oxide layer. Next, a layer of zirconium oxide 10 (a thermal barrier layer) is deposited. Finally, a thick layer of nickel-aluminum alloy 12 is deposited on the structure for mechanical strength. The thermally sprayed layers are then removed from the object by immersing the coated part in sodium hydroxide to dissolve the aluminum to form the shaped heater.

### EXAMPLE 2

### Use of a Shaped Heater

In one particular example of a use of a shaped heater, the resistive layer of the shaped heater of Example 1 is electrically coupled to a power supply. The heater is then placed in conformal contact with a vacuum pump. The heater is then clamped into placed. Heat conductive paste may be used to ensure good thermal transfer from the heater to the vacuum pump. When current is applied to the heater, the resistive layer produces heat.

### EXAMPLE 3

### Mold Having a Shell with an Integrated Heater

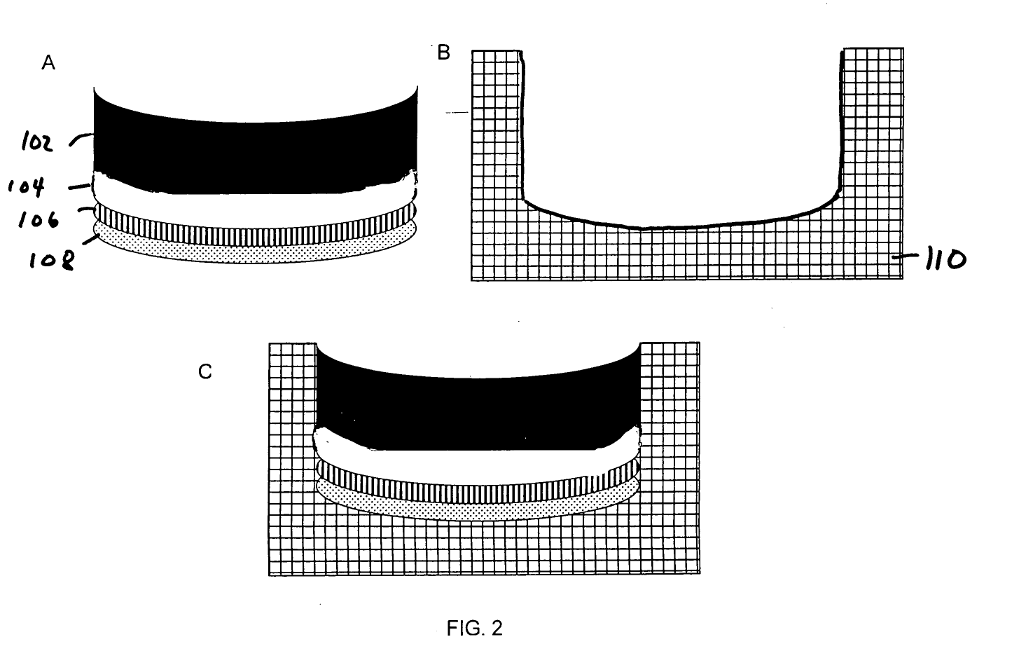

One example of a mold according to the invention is depicted in FIGS. 2A-2C. This mold includes a shell 102 that determines the shape of the molded part and a housing 110 to hold the shell and provide physical support. The shell may be made by electroforming nickel or copper around the plastic part. The housing is shaped to be approximately complementary to the back, i.e., the surface not in contact with the molded material, of the shell. In this example, an electrically insulating layer 104 is applied to the back of the shell or a portion thereof by, for example, applying a layer of high dielectric strength porcelain, and a resistive layer 106 is deposited on the electrically insulating layer. A thermal barrier layer 108 may then be applied to direct heat into the shell and the interior of the mold. Electrical connections to the resistive layer can be made such that the shell plugs, e.g., by banana plugs, into an outlet in the housing. Because the layers are applied to the back of a shell, this method has the advantages of ease of applying the layers, ease of making electrical connections, and ease of manufacture, since the mold surface does not need to be re-machined after application of the layers. The shell is attached, e.g., by clamps or bolts, to the housing during use.

This configuration allows for the replacement of the both the heater and the cavity surface, each which may degrade over time, in a single operation. In various embodiments of this configuration, the shell may be a coating, e.g., one that is applied to a formed resistive heater.

### EXAMPLE 4

### Mold Having a Shell and a Removable Shaped Heater

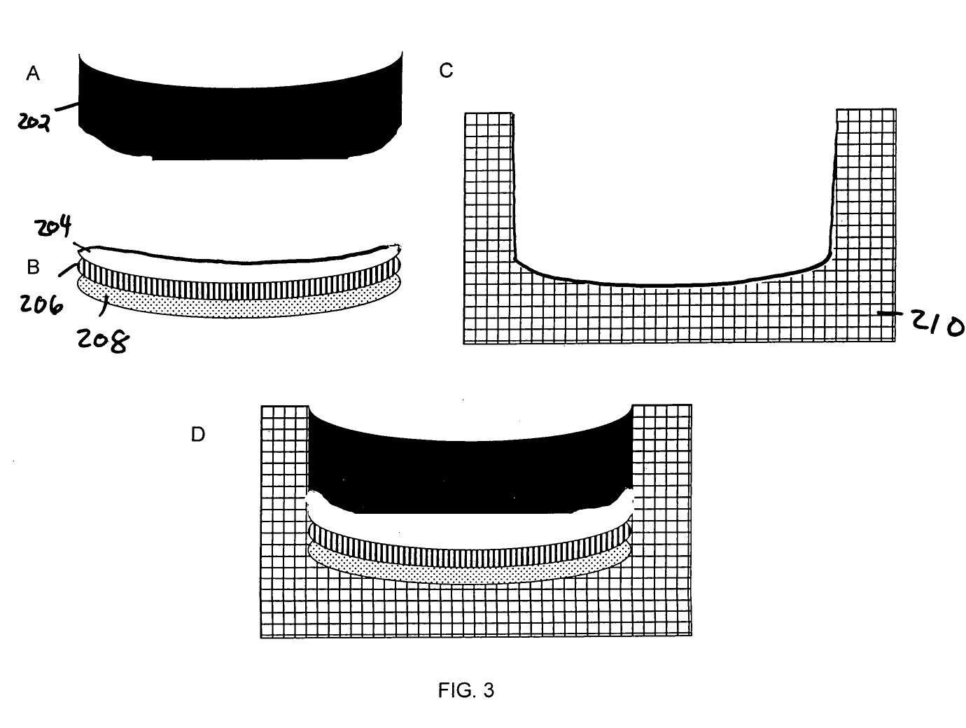

Another example of a mold according to the invention is depicted in FIGS. 3A-3D. This mold includes three parts, a shell 202 that determines the shape of the molded part, a shaped heater 204-208 that conforms to the back of the shell, and a housing 210 to hold the shell and shaped heater and provide physical support. The heater is fabricated by thermally spraying a layer of aluminum oxide 204 (an electrical insulator) on an object shaped similarly to the back of the shell or a portion thereof. Titanium is then thermally sprayed in the presence of nitrogen to form a resistive layer 206 on the aluminum oxide layer. A layer of zirconium oxide 208 (a thermal barrier layer) is then thermally sprayed on the resistive layer. The thermally sprayed layers are then removed from the object by delamination to form the shaped heater. The mold is then assembled by sandwiching the shaped heater between the shell and the housing. The shell and shaped heater are attached, e.g., by clamps or bolts, to the housing and/or each other.

### EXAMPLE 5

### Fabrication of a Thermoplastic Molded Part

A thermoplastic melt may be injected into any of the molds of the invention, such as those disclosed in Example 3 or Example 4. The shaped heater of the mold is heated in order to prevent freezing of the melt when it contacts the cavity surface of the mold. After the mold has been filled with the melt, the heat is turned off, and the mold is cooled until the molded part solidifies. The part is then ejected from the mold. Because only a small part of the entire mold is heated and cooled, the cycle time of this mold is shorter than molds that heat the entire mold.

### EXAMPLE 6

### Fabrication of a Thermoset Molded Part

A thermoset material may also be injected into any of the molds of the invention, such as those described in Example 3 or Example 4. The shaped heater of the mold then heats the thermoset material until it solidifies. When the part has solidified, it can be ejected from the mold with or without cooling the mold.

### EXAMPLE 7

### Removal and Replacement of a Heater

If desired, the heaters of the invention may be removed and replaced. A heater of the invention may fail, i.e., no longer produce a desired amount of heat, after a number of uses. The failure is, for example, the result of mechanical damage, overheating, application of too much current, or chemical modification. When a shaped heater fails, it can be removed from conformal contact and replaced with a new heater. Heaters may also be removed for maintenance, to be replaced by a heater that produces more or less heat, or to use in a different apparatus.

### EXAMPLE 8

### Lenticular Mold

A lenticular mold surface is made by machining a thin walled steel cavity with an outside surface formed to receive a separate insulator and heater assembly. An electrical insulator element, resistive element, and thermal barrier element are all comprised of materials which are machinable using conventional ceramic and metal machining methods, e.g., aluminum nitride electrical insulator, silicon carbide resistive heater, and mullite thermal barrier layer. These elements are configured to nest tightly together in a cavity below the mold surface.

### EXAMPLE 9

### Mold Having a Shaped Heater and a Cooling Jacket

Any mold of the invention may include a cooling jacket. The cooling jacket is a channel or cavity or series thereof through which a cooling liquid or gas flows. A cooling jacket is used to cool a mold more quickly than radiant transfer of heat. The cooling jacket is located in proximity to the heater of the invention, e.g., within a shell or housing of Examples 3 or 4, integrated with the substrate on which the heater is deposited, or fabricated as a separate part of the mold.

### EXAMPLE 10

### Mold Having Multiple Shaped Heaters

A mold of the invention may contain more than one shaped heater of the invention. In one example, more than one heater is in conformal contact with the shell. In another example, at least a portion of one heater is disposed between the shell and at least a portion of one or more other heaters.

### EXAMPLE 11

### Mold Having a Thermocouple Array

A mold of the invention may include an array of thermocouples in order to monitor the temperature of the mold. The array is distributed around the mold to generate a profile of the temperature of the entire mold or a portion thereof. Thermocouples are commercially available or are fabricated as described in U.S. application Ser. No. ______, filed Aug. 15, 2002, entitled RESISTIVE HEATERS AND USES THEREOF.

### Other Embodiments

All publications, patents, and patent applications mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in thermal spraying, coatings, thermoplastics, or related fields are intended to be within the scope of the invention.

Other embodiments are in the claims.

What is claimed is:

1. A shaped resistive heater comprising a resistive element and an electrically insulating element, wherein said heater has a fixed, non-planar shape that is conformal to at least a portion of an object to be heated, wherein said heater is not adhered to said object.

2. The heater of claim 1, comprising two electrically insulating elements, wherein said resistive element is disposed between said electrically insulating elements.

3. The heater of claim 1, further comprising a power supply that is electrically coupled to said resistive element, wherein the application of current from said power supply results in the production of heat by said resistive element.

4. The heater of claim 1, further comprising a thermal barrier element.

5. The heater of claim 4, wherein said thermal barrier element comprises zirconium oxide.

6. The heater of claim 1, wherein said electrically insulating element comprises aluminum oxide, silicon dioxide, or mica.

7. The heater of claim 1, wherein said resistive element comprises a Ni—Cr alloy, titanium (Ti), silicon (Si), aluminum (Al), zirconium (Zr), cobalt (Co), nickel (Ni), iron (Fe), FeCrAl, or alloys thereof.

8. The heater of claim 1, wherein said resistive element is formed by thermally spraying, machining, casting, sintering, PVD, or CVD.

9. The heater of claim 1, further comprising one or more additional resistive elements.

10. The heater of claim 1, further comprising one ore more thermal sensors.

11. The heater of claim 10, wherein said thermal sensors comprise an array of thermocouples.

12. A method of heating an object, said method comprising the steps of:
a) providing a shaped resistive heater comprising a resistive element and an electrically insulating element, wherein said heater has a fixed, non-planar shape that is conformal to at least a portion of said object, wherein said heater is not adhered to said object;
b) placing said heater into conformal contact with said object; and
c) applying current to said resistive element to produce heat.

13. The method of claim 12, further comprising the step of (c) replacing said shaped heater with a second shaped heater after one or more applications of current to said resistive element.

14. A mold comprising:
a) a shell comprising a cavity side and a back side, wherein said cavity side defines a mold cavity;
b) a resistive heater comprising a resistive element and an electrically insulating element, wherein said heater is shaped to conform to at least a portion of said back side of said shell, and said heater is in conformal contact with said back side of said shell; and
c) a housing capable of physically supporting said shell and said heater, wherein said heater is disposed between said shell and said housing.

15. The mold of claim 14, wherein said resistive heater in step (b) is adhered to at least a portion of said back side of said shell.

16. The mold of claim 14, wherein said resistive heater in step (b) is not adhered to said shell.

17. The mold of claim 14, further comprising a thermal barrier element disposed between said heater and said housing.

18. The mold of claim 14, further comprising a cooling jacket.

19. The mold of claim 14, wherein said resistive heater is coupled to a power supply, wherein application of current from said power supply results in production of heat by said resistive element.

20. The mold of claim 14, wherein an electrically insulating element is disposed between said resistive element and said back side.

21. The mold of claim 14, wherein an electrically insulating element is disposed between said housing and said resistive element.

22. The mold of claim 14, further comprising one or more additional heaters.

23. The mold of claim 22, wherein said one or more additional heaters are in conformal contact with said back said.

24. The mold of claim 22, wherein at least a portion of said heater of (b) is disposed between at least a portion of said one or more additional heaters and said back side.

25. The mold of claim 14, further comprising one or more thermal sensors.

26. The mold of claim 25, wherein said thermal sensors comprise an array of thermocouples.

27. A method of making a molded product, said method comprising the steps of:
a) providing a mold comprising:
i) a shell comprising a cavity side and a back side, wherein said cavity side defines a mold cavity;
ii) a resistive heater comprising a resistive element and an electrically insulating element, wherein said heater is shaped to conform to at least a portion of said back side of said shell, and said heater is in conformal contact with said back side of said shell; and
iii) a housing capable of physically supporting said shell and said heater, wherein said heater is disposed between said shell and said housing;
b) heating said resistive heater by the application of current; and
c) injecting a material to be molded into said mold, wherein said heated resistive heater regulates the solidification of said material, thereby forming said molded product.

28. The method of claim 27, wherein said mold further comprises a cooling jacket.

29. The method of claim 27, further comprising step (d) cooling said material in said mold.

30. The method of claim 27, wherein said material is a thermoplastic material, thermoset material, metal, ceramic, cermet, glass, or combination thereof.

31. A method of making a mold, said method comprising the steps of:
a) providing a shell comprising a cavity side and a back side and a housing capable of physically supporting said shell, wherein said cavity side defines a mold cavity; and
b) depositing a resistive element on at least a portion of said back side, wherein when said shell is supported by said housing, said resistive element is disposed between said shell and said housing.

32. The method of claim 31, further comprising the steps of:
c) forming an electrically isolated, resistive heater path in said resistive element; and
d) connecting said resistive heater path of step (c) to a power supply, thereby fabricating a resistive heater.

33. The method of claim 32, wherein said forming in step (c) is by micromachining, microabrading, laser cutting, chemical etching, or e-beam etching.

34. The method of claim 31, further comprising the step, prior to step (b), of depositing an electrically insulating element on at least a portion of said back side of said shell.

35. The method of claim 31 further comprising the step of:
c) depositing a thermal barrier element on at least a portion of said resistive element.

36. The method of claim 31, wherein said shell is produced by electroplating, electroless deposition, molding, spray forming, machining, CVD, or PVD.

37. A method of making a mold, said method comprising the steps of:
a) providing a shell comprising a cavity side and a back side and a housing capable of physically supporting said shell, wherein said cavity side defines a mold cavity; and
b) forming a resistive heater that has a shape that is conformal to at least a portion of said back side, wherein when said shell and said resistive heater are supported by said housing, said resistive element is disposed between said shell and said housing.

38. The method of 37, wherein said forming in step (b) comprises:
i) depositing a resistive element on at least a portion of an object replicating at least a portion of the shape of said back side; and
ii) removing said resistive element from said object.

39. The method of 38, further comprising depositing an electrically insulating element on at least a portion of said object prior to step (i), wherein said removing in step (ii) also removes said electrically insulating element.

40. The method of 38, further comprising depositing an electrically insulating element on at least a portion of said resistive element, before or after step (ii).

41. The method of 38, further comprising depositing a thermal barrier element on at least a portion of said resistive element, before or after step (ii).

42. The method of 38, wherein said depositing comprises thermal spraying.

43. The method of 37, wherein said forming in step (b) comprises:
i) providing a second shell having a shape conformal to at least a portion of said back side; and
ii) depositing a resistive element on said second shell.

44. The method of 43, further comprising depositing an electrically insulating element on at least a portion of said second shell prior to step (ii).

45. The method of 43, further comprising depositing an electrically insulating element on at least a portion of said resistive element.

46. The method of 43, further comprising depositing a thermal barrier element on at least a portion of said resistive element.

47. The method of 43, wherein said depositing comprises thermal spraying.
